(19) United States
(12) Patent Application Publication
(10) Pub. No.: US 2022/0180328 A1
(43) Pub. Date: Jun. 9, 2022

(54) MANAGING RECURRING CALENDAR EVENTS

(71) Applicant: VMware, Inc., Palo Alto, CA (US)

(72) Inventors: Rohit Pradeep Shetty, Bangalore (IN); Erich Stuntebeck, Johns Creek, GA (US)

(21) Appl. No.: 17/113,893

(22) Filed: Dec. 7, 2020

(51) Int. Cl. G06Q 10/10; G06Q 10/06; G06Q 50/00; G06F 16/25; G06N 7/00

(52) U.S. Cl. CPC G06Q 10/1093; G06Q 10/103; G06Q 10/063118; G06Q 10/105; G06N 20/00; G06F 16/252; G06N 7/005; G06Q 10/107; G06Q 50/01

(57) ABSTRACT

Examples described herein include systems and methods for managing a recurring calendar event. An example method for managing a recurring calendar event can include obtaining event information regarding the recurring calendar event. The example method can also include obtaining context information. Context information can include any type of information and can be obtained from a variety of sources, such as an email gateway, backend server, or directory service. The method can include determining a probability that a user will attend the recurring calendar event. If the probability exceeds a threshold, the user can be prompted to modify the recurring calendar event accordingly.

### BACKGROUND

Many users, including most employees at enterprises, have recurring events saved in their electronic calendars. For example, a manager can have a weekly meeting with a junior employee, resulting in both the manager and junior employee having a recurring meeting saved in their respective calendars. As more enterprises move their operations to the digital realm, calendar events continue to proliferate; a trend that will likely continue.

One downside to this proliferation of calendar events is an increasing burden of managing these events. This is especially true in the case of recurring calendar events, which can continue indefinitely. A meeting organizer for a recurring calendar event scheduled to continue indefinitely must manually delete the meeting after determining that the purpose of the meeting has been achieved. Otherwise, the other members of the event must manually delete the meeting from their schedules. A failure to promptly delete a recurring event can inconvenience users and tie up resources, including conference rooms reserved for that event.

Similar issues arise in the example of a recurring event that ends too soon, such as before a project is completed. In that example, if the organizer fails to realize the end date for the recurring event, the event can slip off the calendar without anyone immediately noticing. By the time someone notices the missing meeting, users' calendars can be filled with new events and conference rooms can be reserved for other meetings. As in the previous example, this reduces overall productivity and can lead to frustration.

As a result, a need exists for improved management of recurring calendar events. This can include intelligently determining when a recurring meeting should be canceled, extended, or otherwise changed.

### SUMMARY

Examples described herein include systems and methods for managing a recurring calendar event. As used herein, the term “event” can apply to any occurrence, meeting, reminder, or other entry that can be saved to a digital calendar. A digital calendar, also referred to as a “calendar” herein, is a calendar function provided by software executing on a device having a hardware-based processor and memory. A calendar can be provided by a standalone calendar application, such as the Calendar application on the MacOS and iOS operating systems. A calendar can also be provided within an application that provides additional functionality, such as BOXER, which provides at least email and calendar features. An event can be considered “recurring” when the event is scheduled to happen more than once, such as an event scheduled to occur once a year on the same day, once a month, once a week, daily, or at some other time interval.

An example method for managing a recurring calendar event can include obtaining event information regarding the recurring calendar event. Event information can include any information relevant to the event, such as the event date, event location, event attendees, event type, event organizer, event frequency (recurrence), event name, event agenda, or other event details. In one example, all information available to an event attendee regarding an event is considered event information. This can include a description of the event or attachments to an event invitation. Event information can also include information regarding users that accepted, declined, or did not respond to an event invitation. It can also include information about a user that previously accepted the event invitation but has since declined further occurrences of the event.

In some examples, obtaining event information can include obtaining a calendar file, such as an interne calendar (“iCalendar”) attachment, ICS file, comma-separated value (“CSV”) file, or any other type of calendar file that includes event data. This file can be stored or generated at a user device, which can then send the file to a remote server in response to a request for event information.

The example method can also include obtaining context information. Context information can include any type of information, outside of the event information, that can provide insight into, or be used for managing, the recurring calendar event. Context information is therefore a broad concept that includes various types of information described herein. For example, context information can include employment information about a user invited to the event, a project status relevant to an event, email information, including email content, from a user invited to an event, files associated with a user invited to an event, a physical location of a user, and a device status of a user, to name a few examples. Context information can come from a variety of sources, such as: event history stored on a user device or server, including attendance history indicating whether a user attended one or more historical calendar events, as well as information indicating whether a user cancelled or declined historical calendar events; a backend system that supports a system utilized by a user or enterprise; employment information for a user, including coworkers, supervisors, subordinates, department, office location, start date, and end date; communication records of a user, including email and messaging applications; and information regarding calendar events other than the recurring calendar event of interest.

The example method can further include determining a probability that a user will attend the recurring calendar event of interest. Determination of the probability can be based on event information, context information, or a combination of both. The various pieces of information can be fed into one or more machine learning (“ML”) models as inputs into the models. The ML models can be trained at a server remote from the user's device, using training data. The ML models can execute on the user device or at the server, depending on the circumstances. For example, if a ML model is computationally intensive, the input data can be provided to a server that stores and executes the ML model. On the other hand, if a ML model has a relatively small computational footprint, the input data can be fed to the ML model executing on the user device.

The ML model(s) can output a probability that a user will attend the recurring calendar event. The probability can be a percentage or a number, for example. The example method can include comparing the probability to a threshold. The threshold can be set by the user or by a system administrator (“admin”) in some examples. In other examples, the threshold is dynamically adjusted based on the circumstances. For example, a threshold for a probability of a meeting organizer attending a meeting can be different than a threshold for a probability of a meeting attendee, because the effects of an organizer canceling a meeting are greater than those of an attendee canceling their instance of the meeting.

In an instance where the probability exceeds the relevant threshold, the example method can include prompting the user to modify the recurring calendar event. Prompting the user can include displaying a notification at the operating-system (“OS”) level on the user device, for example. It could also include, additionally or alternatively, displaying a notification within an application such as a calendar application or email application. The notification within the application can include displaying a GUI window with an explanation and options for the user to take an action. For example, the GUI window can explain that the user has not attended a recurring meeting for a threshold number of times and, accordingly, ask the user if they would like to cancel the recurring event to remove it from their calendar. The user can select a GUI element to cancel the meeting (occurrence or series) or to maintain the meeting.

In other examples, the notification can provide alternate explanations regarding why the user is being prompted to cancel or delete the event. For example, the notification can explain that a backend system indicates that a project associated with the recurring event is complete. In another example, the notification can provide an option for an event organizer to remove an attendee from the invitation list, such as when the attendee has left the company or department. In yet another example, the notification can explain that a user's email correspondence indicates that a project has completed, prompting the user to end the associated recurring meeting. In the same vein, the notification can explain that a user's email correspondence indicates that a project is not complete but the recurring event is set to end soon, providing an option for the user to extend the recurring event further into the future.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is an illustration of an example system for managing a recurring calendar event on a user device.

FIG. 2 is a flowchart of an example method for managing a recurring calendar event on a user device.

FIG. 3 is a sequence diagram of an example method for managing a recurring calendar event on a user device.

FIG. 4A is an illustration of an example GUI of a user device being used to manage a recurring calendar event.

FIG. 4B is an illustration of an example GUI of a user device being used to manage a recurring calendar event.

FIG. 4C is an illustration of an example GUI of a user device being used to manage a recurring calendar event.

FIG. 4D is an illustration of an example GUI of a user device being used to manage a recurring calendar event.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

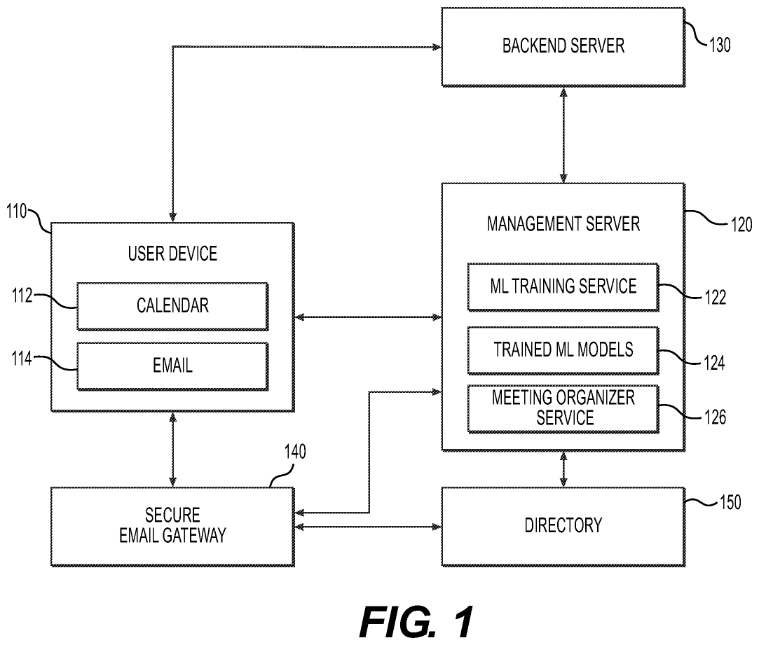

FIG. 1 provides an illustration of a system for managing a recurring calendar event on a user device. The system can include a user device 110, which can be any type of device with a hardware-based process and memory storage. Common examples of a user device 110 can include phones, tablets, laptop computers, and desktop computers. The user device 110 can be an enterprise-owned device that has been assigned to the user for work tasks. It could also be an employee-owned device in some examples.

The user device 110 can include a calendar 112. The calendar 112 can be any type of digital calendar. In some examples, the calendar 112 is a calendar application, such as the Calendar application on the MacOS and iOS operating systems. In another example, the calendar 112 is functionality provided within an application that provides additional features, such as an email application that includes a built-in calendar. In yet another example, the calendar 112 is a web application that links to a digital calendar stored remotely from the user device 110. The calendar 112 can also be a browser application that is connected to a digital calendar in some examples.

The user device 110 can also include an email functionality 114. As with the calendar 112, the email functionality 114 can be a standalone email application or an email function provided within an application that provides additional functionality. For example, an enterprise application can provide email functionality 114 as well as secure document storage and management functionality. The email functionality 114 can also be embodied in a web application that accesses an email account stored remotely, such as at an email server. The email functionality 114 can also be a web browser that is connected to an email account in some examples.

The system of FIG. 1 also can include a management server 120. The management server 120 can exert some degree of management control over the user device 110 in some examples. The management server 120 can provide credentials, such as a token or certificate, to the user device 110 to allow for secure communication between the management server 120 and user device 110. The management server 120 can collect various types of information from the user device 110, including information stored by the calendar 112 or email functionality 114. The management server 120 can also collect information from other components of the system of FIG. 1, as shown.

The management server 120 can include an ML training service 122 that trains ML models 124. The ML training service 122 can train a model using training data provided to the model, such as a sample dataset provided by an admin. The ML training service 122 can train ML models 124 to perform various determinations, including calculating probabilities that a user will attend or not attend a calendar event. The trained ML models 124 can be trained to accept various types of input, such as the various types of event information and context information described herein.

The ML models can execute on the user device 110 or at a server, such as the management server 120. For example, if a ML model 124 is computationally intensive, the input data can be provided to a server that stores and executes the ML model 124. On the other hand, if a ML model 124 has a relatively small computational footprint, the ML model 124 can be stored on the user device 110 such that the input data can be fed to the ML model 124 executing on the user device 110.

The management server 120 can also include a meeting organizer service 126. the meeting organizer service 126 can provide input to the ML models 124 and interpret output from the ML models 124. For example, the meeting organizer service 126 can set thresholds for various determinations, either by default or with input from an admin. The meeting organizer service 126 also can compare the output of an ML model 124 to a threshold, and depending on the outcome of that comparison, take further action as needed. For example, the meeting organizer service 126 can cause a prompt or notification to be displayed at the user device 110, as explained in more detail later in this disclosure.

The system of FIG. 1 also can include a backend server 130. The backend server 130 can be a server that supports one or more backend systems available to the user of the user device 110. The backend system can be a third-party system in some examples, such as JIRA, SALESFORCE, or CONCUR. The backend system need not be a third-party system, however, and can alternatively be a system owned or managed by the enterprise at which the user of the user device 110 is employed. The backend server 130 can store information relevant to the user, such as teams the user is a member of, projects the user has been assigned to, expenses attributed to the user, and any other information relevant to the supported backend system(s). The backend server 130 can provide this information to the management server 120 or user device 110 upon request, such as by a request that includes an appropriate credential.

In some examples, the backend server 130 provides an integrated project-tracking tool for a calendar 112, such as by associating a recurring event with a specific project. The integrated tool can receive updates from the backend server 130 regarding milestones being achieved for a project, such as status changes for tasks resulting in resolved or closed issued. These updates can be used to indicate the stage of a project and the need, or lack thereof, for a recurring event relating to that project.

The system of FIG. 1 also can include a secure email gateway (“SEG”) 140. The SEG 140 can be a device, such as a server, or software executing on a device, that monitors emails coming to and from an email server (not shown). The SEG 140 can filter out unwanted messages such as spam or malware while allowing wanted emails through to the recipient. The SEG 140 can also enforce various rules, such as size limits for attachments and privileges for accessing an email server. For example, the SEG 140 can enforce a compliance rule indicating that the user device 110 must be enrolled with the management server 120 before allowing the user device 110 to have access to an email server. The SEG 140 can also query a separate server or service, such as the management server 120, to request information about a user before granting access. For example, the SEG 140 can confirm with the management server 120 that a user is still employed at the company before allowing the user to access email delivered to their email account.

The system of FIG. 1 can include a directory 150. The directory 150 can be a service or process, or set of services and processes, executing on a computing device. In some examples, the directory 150 is a standalone server executing those services and processes. The directory 150 can store information about users within a domain, verify credentials, and grant or deny access rights. The directory 150 can authenticate and authorize users and devices within a network, such as by assigning and enforcing security policies. The directory 150 can also provide a data store for directory data, allowing for easily retrieval of directory data regarding a user or user device 110. For example, the directory 150 can store objects representing an entity, such as a user or a device, as well as information about that entity. An example of a directory 150 is MICROSOFT'S ACTIVE DIRECTORY. The directory 150 can provide information to the SEG 140, management server 120, or user device 110 in some examples.

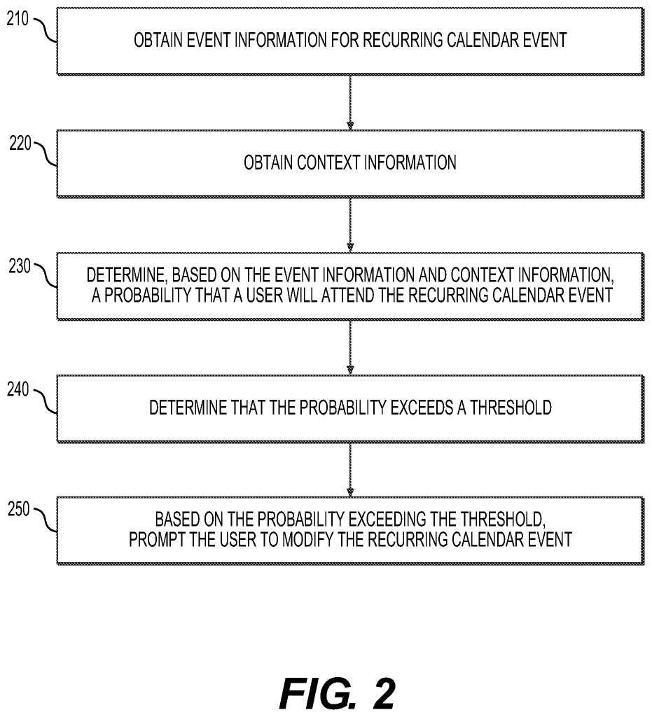

FIG. 2 provides a flowchart of an example method for managing a recurring calendar event on a user device. At stage 210 the management server 120 can obtain event information for the recurring calendar event. In one example, the user device 110 can execute an agent that communicates with the calendar 112 to obtain the event information and then provide the information to the management server 120. The event information can include any information relevant to the event, such as the event date, event location, event attendees, event type, event organizer, event frequency (recurrence), event name, event subject or topic, event agenda, or other event details. In one example, all information available to an event attendee regarding an event is considered event information. This can include a description of the event or attachments to an event invitation. Event information can also include information regarding users that accepted, declined, or did not respond to an event invitation. It can also include information about a user that previously accepted the event invitation but has since declined further occurrences of the event.

Event information can provide useful information for future determinations. For example, a topic of subject of an event can indicate a potential timespan for the event. In one example, a meeting subject or topic is “End of Quarter planning,” indicating that this recurring event is likely not relevant beyond the end of the quarter. The system can, at a later stage, obtain context information from an accounting server regarding the dates associated with each quarter in order to determine when the meeting should end. Similarly, this information can be used to suggest a new recurring meeting for the following quarter, such as by suggesting an “End of Quarter planning” meeting at a similar timeframe with respect to the following quarter. Similarly, this information can be used while a user is establishing a new recurring event. For example, if the user does not select an end date for the “End of Quarter planning” meeting, or selects an end date that extends beyond the end of the quarter, the system can recommend setting an end date that aligns more closely with the end of the quarter.

Event information can be stored in a file, such as an iCalendar attachment, ICS file, or CSV file. In some examples, the file with event information can be stored at the user device 110. This stage can be performed by the user device 110 or the management server 120. For example, the user device 110 can obtain the event information by storing or accessing the event file. In another example, the management server 120 can receive the event file from the user device 110, such as in response to a request made by the management server 120.

Stage 220 of the method can include the management server 120 obtaining context information, such as by utilizing an application programming interface (“API”) call to an information source external to the management server 120. Context information can include any type of information that is not event information. Context information can come from a variety of sources, such as: event history stored on a user device or server, including attendance history indicating whether a user attended one or more historical calendar events, as well as information indicating whether a user cancelled or declined historical calendar events; a backend system that supports a system utilized by a user or enterprise; employment information for a user, including coworkers, supervisors, subordinates, department, office location, start date, and end date; communication records of a user, including email and messaging applications; and information regarding calendar events other than the recurring calendar event of interest.

Stage 220 can include obtaining the context information from one or more sources. These sources can include, for example, a user device 110, management server 120, backend server 130, SEG 140, directory 150, email server, or a content repository. Stage 220 can include making one more requests from the management server 120 to any, or each, of these potential sources of information. For example, the management server 120 can make an API call to a server for information. The API call can include an identifier of a user, user device 110, or a particular event, allowing the server to return context information potentially relevant to the event. In another example, the management server 120 can send a request to a management agent executing on a device, causing the management agent to gather relevant information and transmit it to the management server 120. Stage 220 can include steps for gathering context information from any number of potential sources.

In some examples, context information includes information regarding other events on a user's calendar. This can indicate, for example, whether a new or overlapping event should replace another event or whether a notification should be sent regarding the end of a recurring event. For example, a team with 10 team members can have a recurring weekly sales call reflected in a calendar event. In this example, the weekly call is renamed as a marketing call rather than a sales call, and a new calendar event for the marketing call is created. The marketing call can include the same 10 team members, along with an 11^{th} member from the marketing team. Based on the overlap in participants between the sales call and marketing call, a determination can be made at a later stage that the sales call should be removed from the calendar. In an example where the sales call was already set to end, a determination can be made at a later stage that the user should not be prompted regarding extending the weekly sales call, as it has likely been replaced by the marketing call.

Stage 230 can include the management server 120 determining, based on the event information and context information, a probability that a user will attend the recurring calendar event. For example, the management server 120 can provide the event information and context information to one or more ML models 124 that have been trained by the ML training service 122. The ML models 124 can execute on the user device 110 or at the management server 120, depending on the circumstances. For example, if a ML model 124 is computationally intensive, the input data can be provided to the management server 120 that stores and executes the ML model 124. On the other hand, if a ML model 124 has a relatively small computational footprint, the input data can be fed to the ML model 124 executing on the user device 110. In that example, the management server 120 can provide event information and context information to the user device 110 for use with the ML model 124. The ML model(s) 124 can output a probability that a user will attend, or not attend, the recurring calendar event. The probability can be a percentage or a number, for example.

Stage 240 can include the management server 120 determining that the probability exceeds a threshold. This stage can include comparing the probability to a threshold, which can be set by the user or by an admin in some examples. In other examples, the threshold is dynamically adjusted based on the circumstances. For example, a threshold for a probability of a meeting organizer attending a meeting can be different than a threshold for a probability of a meeting attendee, because the effects of an organizer canceling a meeting are greater than those of an attendee canceling their instance of the meeting. The management server 120 can store the threshold and retrieve it to compare the probability at this stage.

At stage 250, in an instance where the probability exceeds the relevant threshold, the example method can include the management server 120 causing the user device 110 to prompt the user to modify the recurring calendar event. Prompting the user can include displaying a notification at the OS level on the user device, for example. It could also include, additionally or alternatively, displaying a notification within an application such as a calendar application 112 or email application 114. The notification within the application can include displaying a GUI window with an explanation and options for the user to take an action. For example, the GUI window can explain that the user has not attended a recurring meeting for a threshold number of times and, accordingly, ask the user if they would like to cancel the recurring event to remove it from their calendar. The user can select a GUI element to cancel the meeting (occurrence or series) or to maintain the meeting.

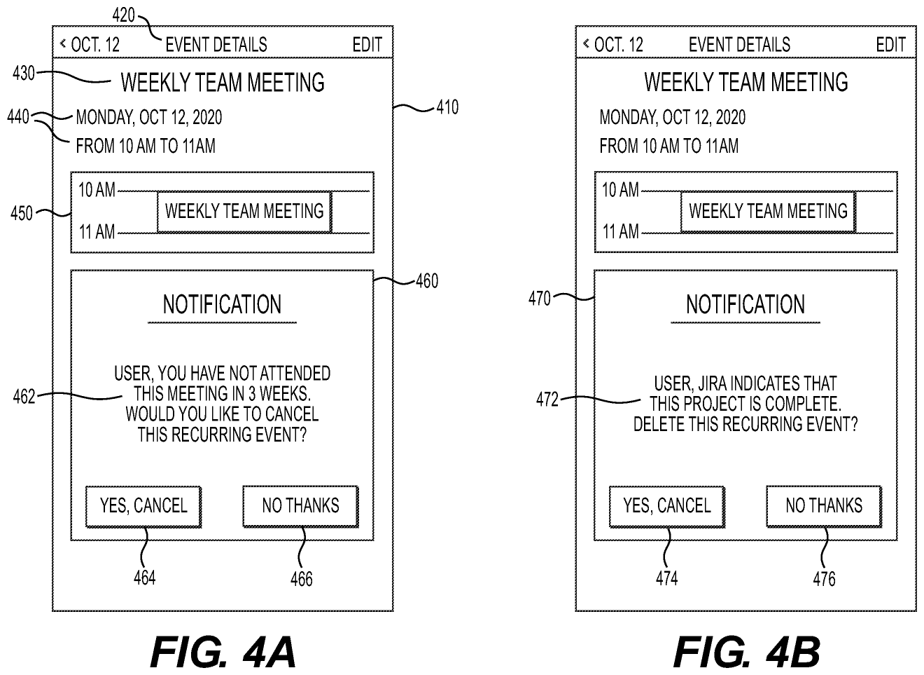

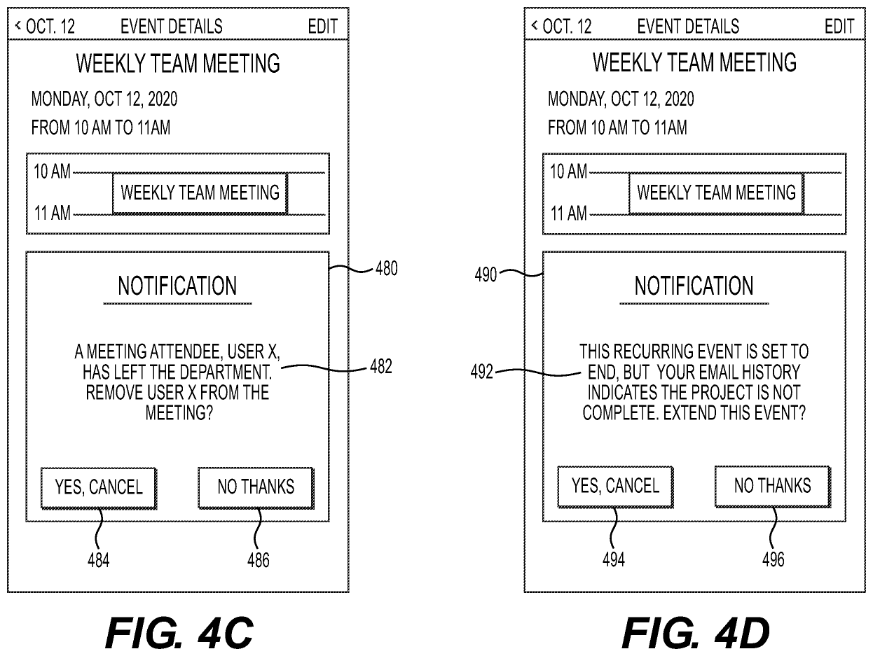

In other examples, the notification can provide alternate explanations regarding why the user is being prompted to cancel or delete the event. For example, the notification can explain that a backend system indicates that a project associated with the recurring event is complete. In another example, the notification can provide an option for an event organizer to remove an attendee from the invitation list, such as when the attendee has left the company or department. In yet another example, the notification can explain that a user's email correspondence indicates that a project has completed, prompting the user to end the associated recurring meeting. Similarly, the notification can explain that a user's email correspondence indicates that a project is not complete, but because the recurring event is set to end soon, the notification can provide an option for the user to extend the recurring event further into the future. Prompting the user as described above is shown and discussed in more detail with respect to FIGS. 4A-4D.

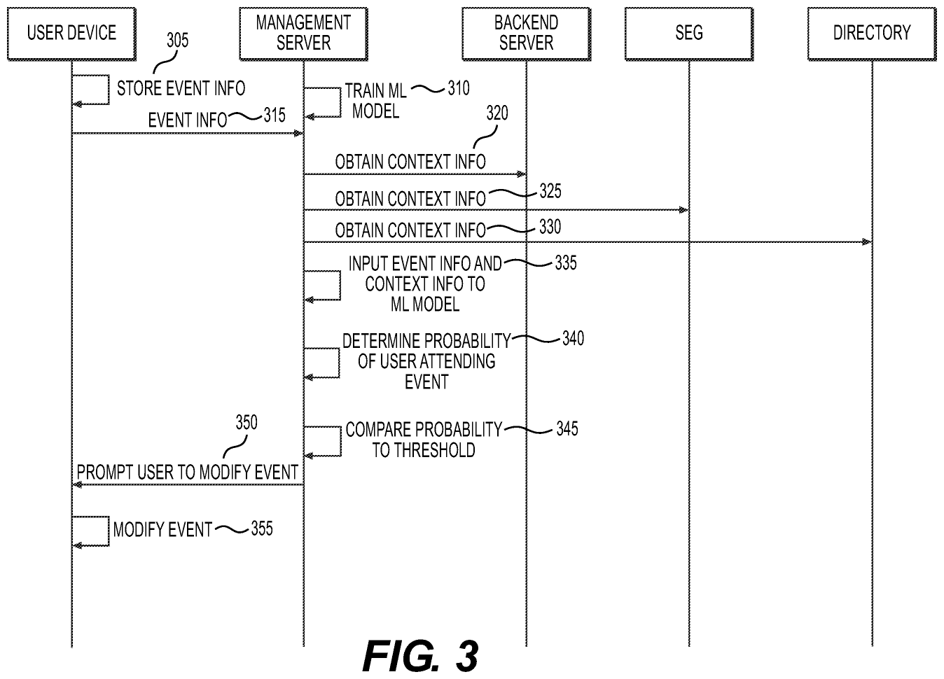

FIG. 3 provides a sequence diagram of an example method for managing a recurring calendar event on a user device 110. At stage 305, the user device 110 can store event information. This can occur in a variety of ways. In one example, a user receives an invitation to a meeting. Regardless of whether the user accepts, declines, or does not respond to the meeting invitation, the details of the meeting can be stored at the user device 110, such as within a memory store of the device 110. As mentioned previously, event information can include any information relevant to the event, such as the event date, event location, event attendees, event type, event organizer, event frequency (recurrence), event name, event agenda, or other event details.

In another example, a user creates a meeting using a calendar application 112 on the user device 110, including several attendee email addresses in the meeting invitation. The details of the meeting, including the subject, date, location, organizer, and attendees, can be saved to the user device 110. This event information can be saved even if the meeting invitation is not sent to anyone, such as when the user saves a draft of the invitation or sets the invitation to be sent at a later time.

At stage 310, the management server 120 can train one or more ML models 124. This stage can occur independently of the other stages in FIG. 3—for example, the ML models 124 can be trained prior to the other stages of the method being performed. The management server 120 can include an ML training service 122 that trains ML models 124. The ML training service 122 can train a model using training data provided to the model, such as a sample dataset provided by an admin. The ML training service 122 can train ML models 124 to perform various determinations, including calculating probabilities that a user will attend or not attend a calendar event. The trained ML models 124 can be trained to accept various types of input, such as the various types of event information and context information described herein. In the example method of FIG. 3, the ML models 124 are trained at the management server 120, though in other examples they can be trained elsewhere, such as at a server dedicated to training ML models 124.

At stage 315, the user device 110 can provide the stored event information to the management server 120. Along with the stored event information, the user device 110 can provide a credential or other identification of the user device 110 or user. For example, it can provide a user ID or device ID. The user device 110 can transmit the stored event information in response to a request from the management server 120 in some examples. In other examples, the user device 110 automatically transmits the stored event information based on a change in the stored event information, such as a new meeting being created or a new meeting invitation being received.

At stage 320, the management server 120 can obtain context information from a backend server 130. The backend server 130 can be a server that supports one or more backend systems available to the user of the user device 110, such as a third-party system like JIRA, SALESFORCE, or CONCUR. The backend system need not be a third-party system, however, and can alternatively be a system owned or managed by the enterprise at which the user of the user device 110 is employed. The backend server 130 can store information relevant to the user, such as teams the user is a member of, projects the user has been assigned to, expenses attributed to the user, and any other information relevant to the supported backend system. The backend server 130 can provide this information to the management server 120 as part of stage 320, such as in response to a request that includes an appropriate credential.

In some examples, the backend server 130 provides an integrated project-tracking tool for a calendar 112, such as by associating a recurring event with a specific project. The integrated tool can receive updates from the backend server 130 regarding milestones being achieved for a project, such as status changes for tasks resulting in resolved or closed issued. These updates can be used to indicate the stage of a project and the need, or lack thereof, for a recurring event relating to that project.

In some examples, context information includes information regarding other events on a user's calendar. This can indicate, for example, whether a new or overlapping event should replace another event or whether a notification should be sent regarding the end of a recurring event. For example, a team with 10 team members can have a recurring weekly sales call reflected in a calendar event. In this example, the weekly call is renamed as a marketing call rather than a sales call, and a new calendar event for the marketing call is created. The marketing call can include the same 10 team members, along with an 11^{th} member from the marketing team. Based on the overlap in participants between the sales call and marketing call, a determination can be made at a later stage that the sales call should be removed from the calendar. In an example where the sales call was already set to end, a determination can be made at a later stage that the user should not be prompted regarding extending the weekly sales call, as it has likely been replaced by the marketing call.

At stage 325, the management server 120 can obtain context information from the SEG 140. In one example, the management server 120 provides a user ID corresponding to the user of the user device 110 and requests information regarding the user. The SEG 140 can provide various types of information. In one example, the SEG 140 provides historical data regarding emails sent and received by the user, including the senders, recipients, frequency, and dates and times. The SEG 140 can also provide information regarding authentication attempts and results by the user, including the devices used for each attempt. For example, the SEG 140 can indicate that the user device 110 failed a compliance check on a particular date. The SEG 140 can provide information in one or more CSV or JSON files, for example. As part of stage 325, the SEG 140 can provide this information in response to a request that includes an appropriate credential associated with the user.

At stage 330, the management server 120 can obtain context information from the directory 150. The directory 150 can provide information regarding the user, such as a profile reflecting the user's current information and status. For example, the profile can include the user's role in the organization, department, and office/branch location. In some examples, the profile can include a list of the user's supervisors as well as employees that report to the user. Similarly, the profile can include a list of employees at the same level of the user, such as employees that the user collaborates with on a project. The profile can also include information about the user's current employment status, such as whether the user is currently employed, on vacation, on medical leave, or has left the enterprise. As part of stage 330, the directory 150 can provide the user's profile in response to a request that includes an appropriate credential associated with the user.

At stage 335, the management server 120 can input information into one or more ML models 124. For example, the management server 120 can input the event information obtained at stage 315, the content information obtained at stages 320, 325, or 330, or any combination thereof. For example, the ML model 124 can be configured to accept certain types of input, such as ICS or CSV files, or profiles stored by the directory 150. In some examples, the ML model 124 can accept as input all of the various types of information described herein. The management server 120 can designate a storage location for input information available to the ML model 124 and instruct the ML model 124 to retrieve the stored information.

At stage 340, the ML model 124 can provide an output representing a probability of a user attending an event. The output can be a percentage, such as 80% (or 0.8), which would indicate an 80% predicted chance that the user will attend the event. When an event includes multiple participants, the ML model 124 can provide a probability for each of the individuals invited to the event, in some examples.

In one example, a recurring weekly meeting is approximately four months old, having been automatically scheduled each week for four months. The weekly meeting can include attachments that, in this example, have not been edited in over a month. Additionally, in this example, email correspondence between participants in the weekly meeting has decreased by more than 50% in the last month. These factors can be provided to the ML model 124 as inputs for the model, either alone or along with additional inputs, resulting in a less than 50% overall chance that the relevant user will attend the meeting. In another example, the ML model 124 can calculate a probability based on each input and average those probabilities. In an example, the average can be weighted based on the importance of each input, such as by providing a higher weight to email frequency between participants than to whether attachments have been edited recently.

The probability output at stage 340 can be compared to a threshold at stage 345. The threshold can be set by the user in some examples, such as by configuring settings associated with the calendar application 112. The threshold can also be set by an admin in some examples, such as by inputting a threshold into a web portal in communication with the management server 120. In other examples, the threshold is dynamically adjusted based on feedback from one or more users. For example, if a certain percentage of users reject a prompt for cancelling a meeting, the threshold can be adjusted higher such that a lower proportion of users reject the prompt. This can cut down on annoyances for users and ensure that notifications are only provided when they are needed.

Similarly, different users can be assigned different thresholds for purposes of performing stage 345. For example, a threshold for a probability of a meeting organizer attending a meeting can be different than a threshold for a probability of a meeting attendee, because the effects of an organizer canceling a meeting are greater than those of an attendee canceling their instance of the meeting.

At stage 350, if the probability determined at stage 340 is greater than the threshold at stage 345, the management server 120 can prompt the user to modify the relevant recurring calendar event. Prompting the user can include displaying a notification at the OS level on the user device, for example. It could also include, additionally or alternatively, displaying a notification within an application such as a calendar application 112 or email application 114. The notification within the application can include displaying a GUI window with an explanation and options for the user to take an action. For example, the GUI window can explain that the user has not attended a recurring meeting for a threshold number of times and, accordingly, ask the user if they would like to cancel the recurring event to remove it from their calendar. The user can select a GUI element to cancel the meeting (occurrence or series) or to maintain the meeting.

In other examples, the notification can provide alternate explanations regarding why the user is being prompted to cancel or delete the event. For example, the notification can explain that a backend system indicates that a project associated with the recurring event is complete. In another example, the notification can provide an option for an event organizer to remove an attendee from the invitation list, such as when the attendee has left the company or department. In yet another example, the notification can explain that a user's email correspondence indicates that a project has completed, prompting the user to end the associated recurring meeting. Similarly, the notification can explain that a user's email correspondence indicates that a project is not complete, but because the recurring event is set to end soon, the notification can provide an option for the user to extend the recurring event further into the future. Prompting the user as described above is shown and discussed in more detail with respect to FIGS. 4A-4D.

At stage 355, the user device 110 can modify the recurring calendar event in response to the user's selection. This stage can include, for example, cancelling the event from a user's calendar 112. In some examples, this stage includes cancelling the recurring calendar event altogether, such that it is removed from all user's calendars 112. In one example, stage 355 includes removing particular users from the recurring calendar event, such as by revoking their invitation. In another example, this stage includes extending a recurring calendar event that is set to end in the near future. For example, the event can be extended another day, week, month, or indefinitely. In yet another example, stage 355 includes changing the time of an event based on availability of one or more users associated with the event.

Although FIG. 3 describes a method that modifies an existing recurring calendar event, similar stages can be applied to suggest a timeframe or end date when creating a new recurring calendar event. In such an example, stages 305 and 315 can include storing and sending event information regarding a recurring calendar event that has not yet been scheduled, but for which the user is in process of creating. For example, the user can have a window open for creating a meeting, with information such as the subject, recipients, and description already filled in. This information can be stored at stage 305 and provided to the management server 120 at stage 315.

Continuing the example, stages 310 and 320-345 can proceed in the same manner described above. At stage 350, rather than prompting the user to modify an existing event, the management server 120 can cause the user device 110 to prompt the user with a suggestion for an end date for the meeting. For example, if a backend server 130 associated with a relevant third-party service indicates that a project associated with the event is scheduled to last for six months, then at stage 350 the user can be prompted to include an end date six months out. The user can accept the prompt at stage 350, causing the suggestion to be carried out in the event invitation at stage 355.

FIGS. 4A-4D provide illustrations of example GUI pages of a user device 110 being used to management a recurring calendar event. FIG. 4A includes a GUI 410 that can reflect a page within a calendar 112, such as a calendar 112 provided in a calendar application or an email application 114. The GUI 410 includes a title 420 that, in this example, includes the words “Event Details” to reflect that the user has navigated to an Event Details page for a particular event. The event itself can be described in the subject line 430 for the recurring calendar event, which in this case reads “Weekly Team Meeting.”

The GUI 410 of FIG. 4A also includes day and time information 440 indicating the day and time of the meeting. The GUI 410 further includes a visual representation 450 of the recurring calendar event, providing the user with information regarding any conflicting or surrounding meetings.

The GUI 410 also includes a notification 460, also described as a “prompt” throughout this disclosure. The notification 460 includes a message 462 to the user. In this example, the message 462 includes an explanation of why the user is being presented with the notification 460, such as, in this example, the fact that the user has “not attended this meeting in 3 weeks.” This explanation can provide helpful context to the user to understand why the notification 460 is being displayed. The notification 460 also includes a question to the user, asking “Would you like to cancel this recurring event?” and providing GUI elements 464, 466 for responding. This notification 460 can be considered the prompt described at stage 250 of FIG. 2 and stage 350 of FIG. 3.

Regarding the GUI elements 464, 466 of FIG. 4A, GUI element 464 corresponds to a selection to cancel the recurring event, while GUI element 466 corresponds to declining to cancel the recurring event. However, additional or alternative GUI elements could be displayed here. For example, an option can be provided to the user for maintaining this occurrence of the recurring calendar event but canceling future occurrences of the event. Similarly, an option can be provided to the user for cancelling this occurrence of the recurring calendar event but maintaining future occurrences of the event. In another example, the user is provided with a GUI element that, when selected by the user, causes a message, email, or other notification to be sent to the organizer of the meeting event. This can allow the organizer to decide whether to cancel the recurring meeting. The actions taken in response to a user selection of a GUI element 464, 466 can correspond to the modification at stage 355 of FIG. 3.

Although the notification 460 in FIG. 4A (as well as FIGS. 4B-4D) is shown as being displayed within an Event Details view of a calendar event, the notification 460 can be displayed on any GUI page of the user device 110. For example, the notification 460 can be displayed as a standalone OS-level notification, such as a notification that would be displayed on a lock screen of the user device 110. Regardless of where the notification 460 is displayed at the user device 110, its content and functionality can remain the same.

FIG. 4B provides an illustration of the same example GUI 410 of FIG. 4A, but with a different notification 470. In this example, the notification 470 includes a message 472 that a backend system (JIRA, in this example) “indicates that this project is complete.” This explanation can be based on context information obtained from a backend server 130 associated with the backend system. For example, the backend server 130 can provide status information for a project associated with the event, such as by looking up a project based on a project number associated with the recurring calendar event. In this example, the backend server 130 can provide an indication that the project has been completed.

The message 472 of the notification 470 can also ask the user whether he or she would like to delete the recurrent calendar event. The notification 470 can include GUI elements 474, 476 for making this selection. If the user selects GUI element 474, the user device 110 can remove the recurring calendar event from the user's calendar 112. On the other hand, if the user selects GUI element 476, the user device 110 can retain the calendar event. In another example, the user is provided with a GUI element that, when selected by the user, causes a message, email, or other notification to be sent to the organizer of the meeting event. This can allow the organizer to decide whether to cancel the recurring meeting.

FIG. 4C provides an illustration of another view of the GUI 410 of FIGS. 4A and 4B, but with a different notification 480. In this example, the notification 480 includes a message 482 that a user has left the department. This explanation can be based on context information obtained from the management server 120, SEG 140, or directory 150. For example, the user device 110 can receive an indication from one or more of the management server 120, SEG 140, or directory 150 regarding the current status of attendees in the recurring calendar event. This information can include, for example, each person's current employment status as well as their department, office location, and any other relevant employment information. In this example, the information indicates that one user has moved to a different department, potentially indicating that the user is no longer needed for this recurring calendar event.

The message 482 of the notification 480 can also ask the user whether he or she wants to remove the identified user from the meeting. The notification 480 can include GUI elements 484, 486 for making this selection. If the user selects GUI element 484, the user device 110 can remove the user from the list of attendees for the recurring calendar event. If the user device 110 does not have the authority to make this change, for example because a different user is the organizer of the meeting, then the user device 110 can send a message or notification to the organizer of the meeting requesting the removal. In another example, selecting GUI element 484 can cause a message or notification to be sent to the user that left the department, asking them if they would like to be removed from the attendance list for the recurring calendar event. Alternatively, the user can select GUI element 486 to take no further action regarding the notification 480.

FIG. 4D provides an illustration of yet another view of the GUI 410 of FIGS. 4A-4C, but with a different notification 490. In this example, the notification 490 includes a message 492 that the recurring event is set to end, but that the user's email history indicates that the project is not yet complete. This explanation can be based on context information obtained from the SEG 140. For example, the SEG 140 can provide a log showing inbound and outbound emails with respect to the user, along with information regarding the sender or recipient of those emails. In one example, the SEG 140 provides the log to the management server 120, which applies the information as input into a train ML model 124. The ML model 124 can determine that based on the frequency and/so subject matter of emails between the user and another user, a particular project is not yet complete. The meeting organizer service 126 can then determine a probability that the user would keep attending the event, but for the event being scheduled to stop recurring.

Based on that determination, the meeting organizer service 126 can prompt the user with the notification 490 shown in FIG. 4D. The notification can ask the user whether he or she would like to extend the event and provide GUI elements 494, 496 for providing a response. If the user selects the GUI element 494 associated with extending the event, the user device can automatically update the recurring calendar event to have one or more additional occurrences beyond those otherwise scheduled. In some examples, selecting GUI element 494 can cause the user device 110 to launch a window allowing the user to provide more information about extending the event, such as by allowing the user to extend the event by a single occurrence, a specific number of occurrences, or to extend the event indefinitely. If the user is not authorized to make such changes, the selection can cause a message or notification to be sent to a meeting organizer authorized to make such a change. Alternatively, the user can select GUI element 496 to forego extending the meeting.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

1. A method for managing a recurring calendar event, comprising:
obtaining, at a management server from a user device, event information regarding the recurring calendar event;
obtaining, by the management server, context information from one or more sources external from the management server, wherein the context information is obtained from a backend system associating the recurring calendar event with a project;
determining, by the management server based on the event information and context information, a probability that a user will attend the recurring calendar event wherein determining the probability includes determining a status of the project associated with the backend system and the recurring calendar event;
determining, by the management server, that the probability exceeds a threshold; and
in an instance where the probability exceeds the threshold, causing the user device to prompt the user to modify the recurring calendar event.

2. (canceled)

3. The method of claim 1, wherein the context information includes the user's attendance history for the recurring calendar event, and wherein determining the probability includes determining that the user has not attended two most recent occurrences of the recurring calendar event.

4. The method of claim 1, wherein the context information includes employee relationship information, and wherein determining the probability includes determining a change in an employee relationship between the user and a second user.

5. The method of claim 1, wherein the context information includes an indication of previous cancellations of the recurring calendar event, and wherein determining the probability includes determining that a threshold number of previous events of the recurring calendar event have been cancelled.

6. The method of claim 1, wherein the context information includes communication records between the user and a second user, and wherein determining the probability includes determining that the user and second user communicate with one another at least a threshold amount.

7. The method of claim 1, wherein the threshold differs according to whether the user is an attendee or organizer of the recurring calendar event.

8. A non-transitory, computer-readable medium containing instructions that, when executed by a hardware-based processor, performs stages for managing a recurring calendar event, the stages comprising:
obtaining, at a management server from a user device, event information regarding the recurring calendar event;
obtaining, by the management server, context information, wherein the context information is obtained from a backend system associating the recurring calendar event with a project;
determining, by the management server based on the event information and context information, a probability that a user will attend the recurring calendar event wherein determining the probability includes determining a status of the project associated with the backend system and the recurring calendar event;
determining, by the management server, that the probability exceeds a threshold; and
in an instance where the probability exceeds the threshold, causing the user device to prompt the user to modify the recurring calendar event.

9. (canceled)

10. The non-transitory, computer-readable medium of claim 8, wherein the context information includes the user's attendance history for the recurring calendar event, and wherein determining the probability includes determining that the user has not attended two most recent occurrences of the recurring calendar event.

11. The non-transitory, computer-readable medium of claim 8, wherein the context information includes employee relationship information, and wherein determining the probability includes determining a change in an employee relationship between the user and a second user.

12. The non-transitory, computer-readable medium of claim 8, wherein the context information includes an indication of previous cancellations of the recurring calendar event, and wherein determining the probability includes determining that a threshold number of previous events of the recurring calendar event have been cancelled.

13. The non-transitory, computer-readable medium of claim 8, wherein the context information includes communication records between the user and a second user, and wherein determining the probability includes determining that the user and second user communicate with one another at least a threshold amount.

14. The non-transitory, computer-readable medium of claim 8, wherein the threshold differs according to whether the user is an attendee or organizer of the recurring calendar event.

15. A system for managing a recurring calendar event, comprising:
a memory storage including a non-transitory, computer-readable medium comprising instructions; and
a computing device including a hardware-based processor that executes the instructions to carry out stages comprising:
obtaining, at the computing device from a user device, event information regarding the recurring calendar event;
obtaining, by the computing device, context information, wherein the context information is obtained from a backend system associating the recurring calendar event with a project;
determining, by the computing device based on the event information and context information, a probability that a user will attend the recurring calendar event wherein determining the probability includes determining a status of the project associated with the backend system and the recurring calendar event;
determining, by the computing device, that the probability exceeds a threshold; and
in an instance where the probability exceeds the threshold, causing the user device to prompt the user to modify the recurring calendar event.

16. (canceled)

17. The system of claim 15, wherein the context information includes the user's attendance history for the recurring calendar event, and wherein determining the probability includes determining that the user has not attended two most recent occurrences of the recurring calendar event.

18. The system of claim 15, wherein the context information includes employee relationship information, and wherein determining the probability includes determining a change in an employee relationship between the user and a second user.

19. The system of claim 15, wherein the context information includes an indication of previous cancellations of the recurring calendar event, and wherein determining the probability includes determining that a threshold number of previous events of the recurring calendar event have been cancelled.

20. The system of claim 15, wherein the context information includes communication records between the user and a second user, and wherein determining the probability includes determining that the user and second user communicate with one another at least a threshold amount.

21. The system of claim 15, wherein the threshold differs according to whether the user is an attendee or organizer of the recurring calendar event.

22. The method of claim 1, the stages further comprising, in an instance where the probability exceeds the threshold, prompting the user to extend the recurring event based on context information indicating that the project is not completed.

23. The non-transitory, computer-readable medium of claim 8, the stages further comprising, in an instance where the probability exceeds the threshold, prompting the user to extend the recurring event based on context information indicating that the project is not completed.
